(19) United States
(12) Patent Application Publication
(10) Pub. No.: US 2015/0095928 A1
(43) Pub. Date: Apr. 2, 2015

(54) Delivering Content Via A Content Delivery Device That Includes Audio Delivery Capabilities And Video Delivery Capabilities

(71) Applicant: International Business Machines Corporation, Armonk, NY (US)

(72) Inventors: Keith M. Campbell, Cary, NC (US); William M. Megarity, Raleigh, NC (US); Luke D. Remis, Raleigh, NC (US); Christopher L. Wood, Greenville, NC (US)

(73) Assignee: International Business Machines Corporation, Armonk, NY (US)

(21) Appl. No.: 14/043,370

(22) Filed: Oct. 1, 2013

(51) Int. Cl. H04N 21/2662; H04N 21/24; H04N 21/233

(52) U.S. Cl. CPC H04N 21/2662; H04N 21/233; H04N 21/2405
USPC 725/18; 725/14

(57) ABSTRACT

Delivering content via a content delivery device that includes audio delivery capabilities and video delivery capabilities, including: detecting, by a summarization module, that the audio delivery capabilities of the content delivery device have been disabled; identifying, by the summarization module, the content currently being delivered by the content delivery device; and displaying, by the summarization module, visual summary content associated with the content currently being delivered by the content delivery device.

### BACKGROUND OF THE INVENTION

1. Field of the Invention

The field of the invention is data processing, or, more specifically, methods, apparatus, and products for delivering content via a content delivery device that includes audio delivery capabilities and video delivery capabilities.

2. Description of Related Art

Advertisers pay significant amounts of money to deliver advertising content to viewers of television programs, live sporting events, videos delivered via the Internet, and other forms of multimedia content that is delivered to users. With the advent of digital video recorders, advertisers are frequently paying money to deliver advertising content to viewers, with no assurances that the viewer will actually view the advertising content rather than fast forwarding through the content. Advertisers can also have their advertising content fail to reach viewers in other ways. For example, a user that engages a mute function on their television will not receive full advertising content.

### SUMMARY OF THE INVENTION

Methods, apparatuses, and products for delivering content via a content delivery device that includes audio delivery capabilities and video delivery capabilities, including: detecting, by a summarization module, that the audio delivery capabilities of the content delivery device have been disabled; identifying, by the summarization module, the content currently being delivered by the content delivery device; and displaying, by the summarization module, visual summary content associated with the content currently being delivered by the content delivery device.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example content delivery device according to embodiments of the present invention.

FIG. 2 sets forth a flow chart illustrating an example method for delivering content via a content delivery device that includes audio delivery capabilities and video delivery capabilities according to embodiments of the present invention.

FIG. 3 sets forth a flow chart illustrating an additional example method for delivering content via a content delivery device that includes audio delivery capabilities and video delivery capabilities according to embodiments of the present invention.

FIG. 4 sets forth a flow chart illustrating an additional example method for delivering content via a content delivery device that includes audio delivery capabilities and video delivery capabilities according to embodiments of the present invention.

### DETAILED DESCRIPTION OF EXAMPLE EMBODIMENTS

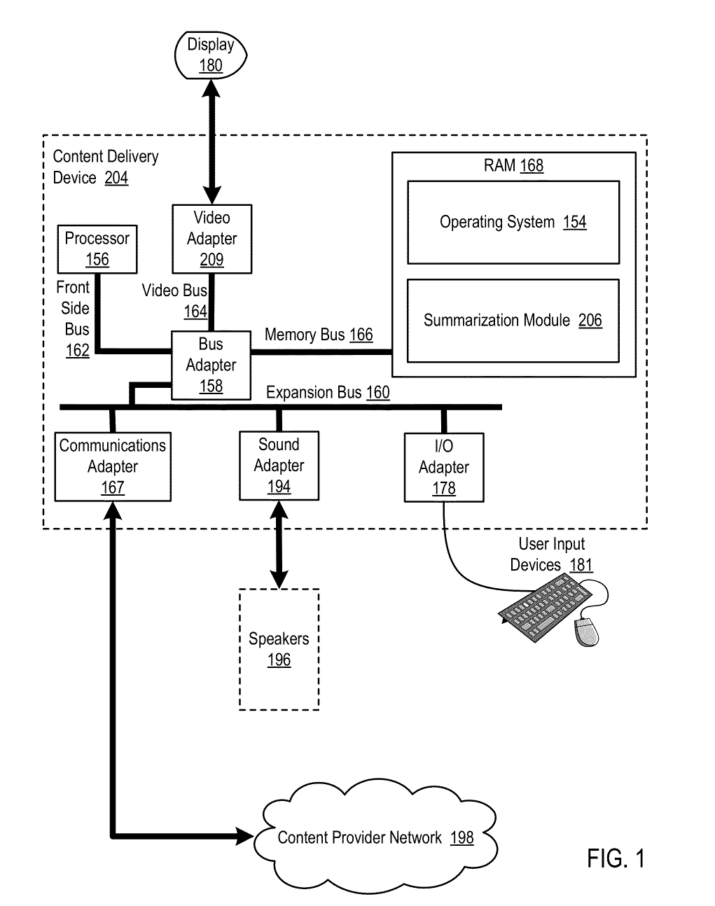

Example methods, apparatuses, and products for delivering content via a content delivery device (204) that includes audio delivery capabilities and video delivery capabilities in accordance with the present invention are described with reference to the accompanying drawings, beginning with FIG. 1. FIG. 1 sets forth a block diagram of automated computing machinery comprising an example content delivery device (204) according to embodiments of the present invention. The content delivery device (204) of FIG. 1 includes at least one computer processor (156) or ‘CPU’ as well as random access memory (168) (‘RAM’) which is connected through a high speed memory bus (166) and bus adapter (158) to processor (156) and to other components of the content delivery device (204).

The content delivery device (204) of FIG. 1 includes audio delivery capabilities. The example of FIG. 1 includes a sound adapter (194) and speakers (196) coupled to the sound adapter. The sound adapter (194) of FIG. 1 represents a computer expansion card that facilitates the input and output of audio signals to and from a computer under control of computer programs. The sound adapter (194) of FIG. 1 may alternatively be embodied as an external audio interface that uses software to generate sound. In the example of FIG. 1, the sound adapter (194) is coupled to speakers (196) for delivering audio content.

The content delivery device (204) of FIG. 1 also includes video delivery capabilities. The example content delivery device (204) of FIG. 1 includes a video adapter (209), which is an example of an input/output (‘I/O’) adapter specially designed for graphical output to a display device (180) such as a touchscreen display, a display on a smart television that includes an embedded summarization module (206), a display screen for a laptop computer, and so on. Video adapter (209) is connected to processor (156) through a high speed video bus (164), bus adapter (158), and the front side bus (162), which is also a high speed bus. In the example of FIG. 1, the video adapter (209) and the display device (180) represent component parts in the video capabilities of the content delivery device (204). Readers will further appreciate that in other embodiments, the display device (180) may be external to the content delivery device (204). For example, the display device (180) may be embodied as a computer monitor when the content delivery device (204) is embodied as a desktop computer, the display screen may be embodied as a television set when the content delivery device (204) is embodied as a set-top box, and so on.

Stored in RAM (168) is a summarization module (206), a module of computer program instructions for delivering content via a content delivery device (204) that includes audio delivery capabilities and video delivery capabilities in accordance with embodiments of the present invention. Although the summarization module (206) of FIG. 1 is depicted as residing within the content delivery device (204) itself, readers will appreciate that this is for explanation and does not represent a limitation of embodiments of the present invention. For example, the summarization module (206) may reside within a digital video recorder (‘DVR’) that is coupled to a television, within a set-top box that is coupled to a television, and so on. In such a way, the summarization module (206) may reside within a device that is in communications with the content delivery device (204) and controls what content the content delivery device (204) delivers.

The summarization module (206) of FIG. 1 may be configured to deliver content via a content delivery device (204) by detecting that the audio delivery capabilities of the content delivery device (204) have been disabled. Detecting that the audio delivery capabilities of the content delivery device (204) have been disabled may be carried out, for example, by inspecting audio settings of the content delivery device (204). For example, the summarization module (206) may receive audio settings of a television and determine that the mute function of the television has been enabled. Likewise, the summarization module (206) may inspect the speaker settings of a laptop computer and determine that the volume level of the laptop is set to 0 on a volume scale where 0 represents the speakers emitting no sound while a setting of 100 represents the speakers emitting sound at full-volume. Readers will appreciate that detecting that the audio delivery capabilities (214) of the content delivery device (204) have been disabled may also be carried out by identifying that audio producing components of the content delivery device (204) are non-operational, by determining that a content signal is defective and includes no audio component, and so on.

The summarization module (206) of FIG. 1 may be further configured to deliver content via a content delivery device (204) by identifying the content currently being delivered by the content delivery device (204). Identifying the content currently being delivered by the content delivery device (204) may be carried out, for example, by inspecting the content received by a content delivery device (204) and examining metadata contained in, or associated with, the content that includes an identifier associated with the content. Consider an example in which the content received by the content delivery device (204) is embodied as a digital television signal from a content provider (200) that is delivered to a television. In such an example, identifying the content (202) currently being delivered by the content delivery device (204) may be carried out, for example, by identifying the current channel that the television is tuned to, determining the current time, and extracting the identification of the content being delivered to television over the current channel at the current time by examining information delivered to the television that is used to generate an electronic program guide (‘EPG’). Alternatively, the digital television signal may include an identification of the content being delivered to the television in the signal itself, such that identifying the content currently being delivered by the content delivery device (204) may be carried out by simply examining the digital television signal.

The summarization module (206) of FIG. 1 may be further configured to deliver content via a content delivery device (204) by transmitting (212), to the video delivery capabilities of the content delivery device (204), visual summary content associated with the content currently being delivered by the content delivery device (204). The visual summary content represents visual content intended to provide a summarization of the content being delivered by the content delivery device (204). In view of the fact that the audio delivery capabilities of the content delivery device (204) have been disabled, all aspects of the content are not being delivered to a user of the content delivery device (204). In particular, the audio components of the content are not being delivered to a user of the content delivery device (204). The visual summary content may therefore be selected to convey important parts of the content that are not being delivered to the user by virtue of the audio delivery capabilities of the content delivery device (204) being disabled.

Consider an example in which the content currently being delivered by the content delivery device (204) is a commercial describing an automobile. In such an example, the visual summary content may include a static image of the automobile, as well as the price of the automobile, financing terms available when purchasing the automobile, and so on. In such a way, the automobile manufacturer that is paying to have their commercial delivered to a user of the content delivery device (204) may still convey important aspects of the advertising message to the user, in spite of the fact that audio delivery capabilities of the content delivery device (204) have been disabled.

In alternative embodiments, the visual summary content may include real-time textual information that is related to the content currently being delivered by the content delivery device (204). Consider an example in which the content currently being delivered by the content delivery device (204) is a broadcast of a football game. In such an example, the visual summary content may include the score of the game, the amount of time remaining in the game, information summarizing the last play, and so on. In such a way, transmitting the visual summary content to the content delivery device (204) may enable the content delivery device (204) to display useful information that is associated with the content currently being delivered by the content delivery device (204), in spite of the fact that the audio delivery capabilities of the content delivery device (204) have been disabled.

Also stored in RAM (168) is an operating system (154). Operating systems useful deliver content via a content delivery device (204) that includes audio delivery capabilities and video delivery capabilities according to embodiments of the present invention include UNIX™ Linux™ Microsoft Windows™ AIX™ IBM's i5/OS™ Apple™ iOS, Android™, and others as will occur to those of skill in the art. The operating system (154) and the summarization module (206) in the example of FIG. 1 are shown in RAM (168), but many components of such software typically are stored in non-volatile memory also, such as, for example, on a disk drive (170).

The content delivery device (204) of FIG. 1 includes disk drive adapter (172) coupled through expansion bus (160) and bus adapter (158) to processor (156) and other components of the content delivery device (204). Disk drive adapter (172) connects non-volatile data storage to the content delivery device (204) in the form of disk drive (170). Disk drive adapters useful in computers for delivering content according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example content delivery device (204) of FIG. 1 includes one or more I/O adapters (178). I/O adapters implement user-oriented input/output through, for example, software drivers and computer hardware for controlling output to display devices such as computer display screens, as well as user input from user input devices (181) such as keyboards and mice.

The example content delivery device (204) of FIG. 1 includes a communications adapter (167) for data communications with a content provider (200). Such data communications may be carried out serially through RS-232 connections, through external buses such as a Universal Serial Bus (‘USB’), through data communications networks such as IP data communications networks, and in other ways as will occur to those of skill in the art. Alternatively, data communications may be carried out carried out over a satellite television network, over an internet protocol television (‘IPTV’) network, and in other ways as will occur to those of skill in the art. As such, the content provider (200) can include a television service provider, a website that delivers streaming media, and so on. Communications adapters implement the hardware level of data communications through which one computer sends data communications to another computer, directly or through a data communications network. Examples of communications adapters useful for delivering according to embodiments of the present invention include Ethernet (IEEE 802.3) adapters for wired data communications network communications, 802.11 adapters for wireless data communications network communications, IPTV tuners and receivers, satellite tuners and receivers, and so on.

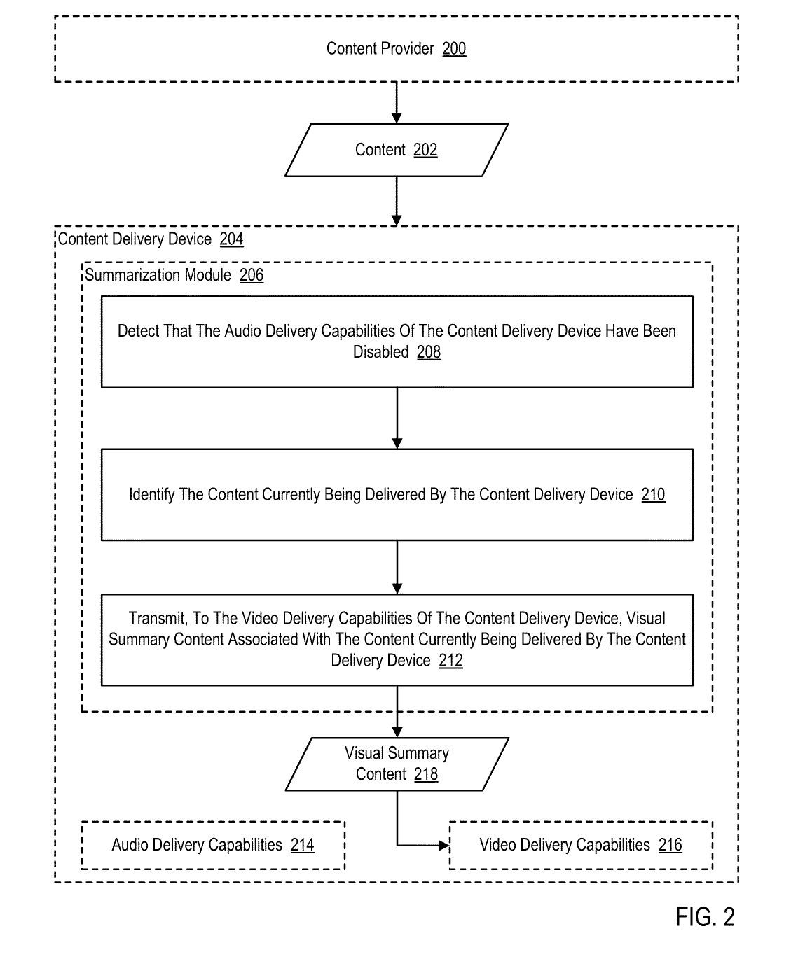

For further explanation, FIG. 2 sets forth a flow chart illustrating an example method for delivering content (202) via a content delivery device (204) that includes audio delivery capabilities (214) and video delivery capabilities (216) according to embodiments of the present invention. In the example method of FIG. 2, the content delivery device (204) may be embodied as any device that can deliver audio content and video content. Examples of such a content delivery device (204) can include a television, a laptop computer, a tablet computer, a smartphone, and so on. Readers will appreciate that although the content delivery device (204) of FIG. 2 is depicted as being a single device, in some embodiments, the content delivery device (204) may actually include attached peripheral devices. For example, the content delivery device (204) of FIG. 2 may be embodied as a television that is coupled with speakers that deliver audio content, as a laptop computer, desktop computer, tablet computer, or other computing device that delivers audio content through a wired connection or wireless connection to a speaker, and so on.

In the example method of FIG. 2, the content delivery device (204) includes audio delivery capabilities (214) and video delivery capabilities (216). In the example method of FIG. 2, the audio delivery capabilities (214) may be embodied as an aggregation of hardware and software that delivers audio content. For example, the aggregation of hardware and software may include the speakers, sound card, drivers, and other components of a computer that are used to deliver audio content. In the example of FIG. 2, the video delivery capabilities (216) may be embodied as an aggregation of hardware and software that delivers video content. For example, the aggregation of hardware and software may include the display screen, video card, drivers, and other hardware and software components of a computer that are used to deliver video content.

Many of the steps depicted in the example method of FIG. 2 are carried out by a summarization module (206). In the example method of FIG. 2, the summarization module (206) may be embodied as a module of computer program instructions executing on computer hardware. Although the summarization module (206) of FIG. 2 is depicted as residing within the content delivery device (204) itself, readers will appreciate that this is for explanation and does not represent a limitation of embodiments of the present invention. For example, the summarization module (206) may reside within a digital video recorder that is coupled to a television.

The example method of FIG. 2 includes detecting (208), by the summarization module (206), that the audio delivery capabilities (214) of the content delivery device (204) have been disabled. In the example method of FIG. 2, detecting (208) that the audio delivery capabilities (214) of the content delivery device (204) have been disabled may be carried out, for example, by inspecting audio settings of the content delivery device (204). For example, the summarization module (206) may receive audio settings of a television and determine that the mute function of the television has been enabled. Likewise, the summarization module (206) may inspect the speaker settings of a laptop computer and determine that the volume level of the laptop is set to 0 on a volume scale where 0 represents the speakers emitting no sound while a setting of 100 represents the speakers emitting sound at full-volume. Readers will appreciate that detecting (208) that the audio delivery capabilities (214) of the content delivery device (204) have been disabled may also be carried out by identifying that audio producing components of the content delivery device (204) are non-operational, by determining that a content signal is defective and includes no audio component, and so on.

The example method of FIG. 2 also includes identifying (210), by the summarization module (206), the content (202) currently being delivered by the content delivery device (204). In the example method of FIG. 2, identifying (210) the content (202) currently being delivered by the content delivery device (204) may be carried out, for example, by inspecting the content (202) received by the content delivery device (204) and examining metadata contained in, or associated with, the content (202) that includes an identifier associated with the content (202). Consider an example in which the content (202) received by the content delivery device (204) is embodied as a digital television signal from a content provider (200) that is delivered to a television. In such an example, identifying (210) the content (202) currently being delivered by the content delivery device (204) may be carried out, for example, by identifying the current channel that the television is tuned to, determining the current time, and extracting the identification of the content being delivered to television over the current channel at the current time by examining information delivered to the television that is used to generate an EPG. Alternatively, the digital television signal may include an identification of the content being delivered to the television in the signal itself, such that identifying (210) the content (202) currently being delivered by the content delivery device (204) may be carried out by simply examining the digital television signal.

The example method of FIG. 2 also includes transmitting (212), by the summarization module (206) to the video delivery capabilities (216) of the content delivery device (204), visual summary content (218) associated with the content (202) currently being delivered by the content delivery device (204). The visual summary content (218) of FIG. 2 represents visual content intended to provide a summarization of the content (202) being delivered by the content delivery device (204). In view of the fact that the audio delivery capabilities (214) of the content delivery device (204) have been disabled, all aspects of the content (202) are not being delivered to a user of the content delivery device (204). In particular, the audio components of the content (202) are not being delivered to a user of the content delivery device (204). The visual summary content may therefore be selected to convey important parts of the content (202) that are not being delivered to the user by virtue of the audio delivery capabilities (214) of the content delivery device (204) being disabled.

Consider an example in which the content currently being delivered by the content delivery device (204) is a commercial describing an automobile. In such an example, the visual summary content may include a static image of the automobile, as well as the price of the automobile, financing terms available when purchasing the automobile, and so on. In such a way, the automobile manufacturer that is paying to have their commercial delivered to a user of the content delivery device (204) may still convey important aspects of the advertising message to the user, in spite of the fact that audio delivery capabilities of the content delivery device (204) have been disabled.

In alternative embodiments, the visual summary content (218) may include real-time textual information that is related to the content (202) currently being delivered by the content delivery device (204). Consider an example in which the content (202) currently being delivered by the content delivery device (204) is a broadcast of a football game. In such an example, the visual summary content (218) may include the score of the game, the amount of time remaining in the game, information summarizing the last play, and so on. In such a way, transmitting (212) the visual summary content (218) to the content delivery device (204) may enable the content delivery device (204) to display useful information that is associated with the content (202) currently being delivered by the content delivery device (204), in spite of the fact that the audio delivery capabilities (214) of the content delivery device (204) have been disabled.

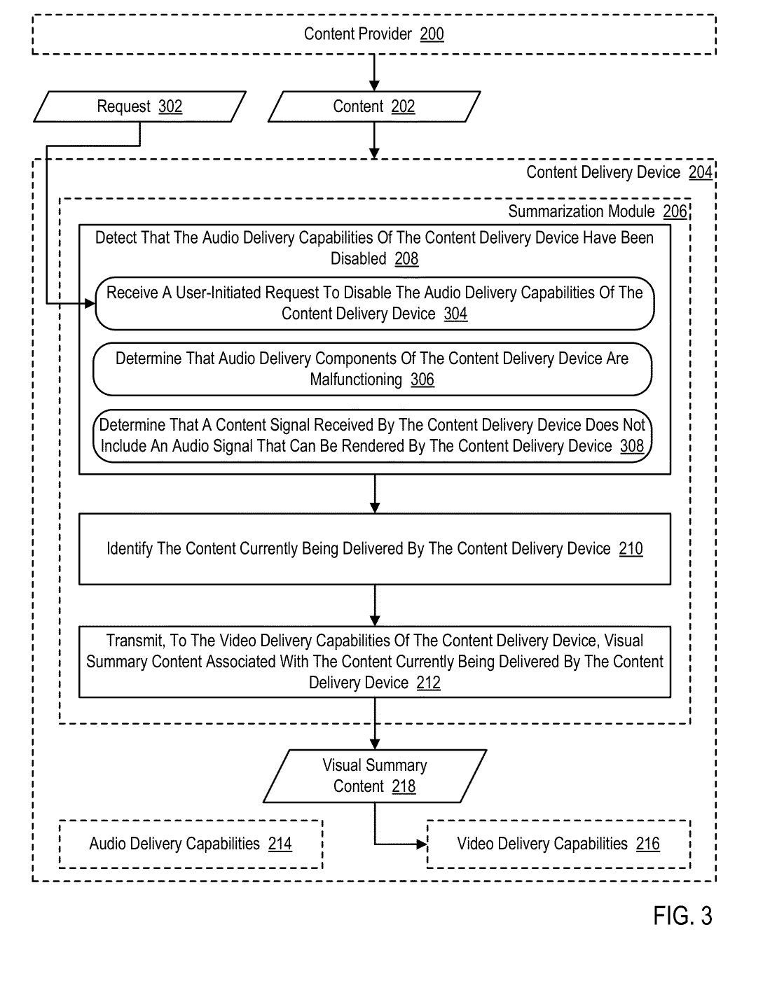

For further explanation, FIG. 3 sets forth a flow chart illustrating an example method for delivering content (202) via a content delivery device (204) that includes audio delivery capabilities (214) and video delivery capabilities (216) according to embodiments of the present invention. The example method of FIG. 3 is similar to the example method of FIG. 2, as it also includes detecting (208) that the audio delivery capabilities (214) of the content delivery device (204) have been disabled, identifying (210) the content (202) currently being delivered by the content delivery device (204), and transmitting (212) visual summary content (218) associated with the content (202) currently being delivered by the content delivery device (204).

In the example method of FIG. 3, detecting (208) that the audio delivery capabilities (214) of the content delivery device (204) have been disabled can include receiving (304) a user-initiated request (302) to disable the audio delivery capabilities (214) of the content delivery device (204). In the example method of FIG. 3, the user-initiated request (302) to disable the audio delivery capabilities (214) of the content delivery device (204) may be embodied, for example, as a television receiving an instruction from a remote control device to enabled the television's mute function, as a user of a smartphone or tablet computer placing a physical switch in a position so as to disabled sound from the smartphone or tablet computer, as a user enabling a mute function on a laptop computer, and so on. In the example of FIG. 3, receiving (304) a user-initiated request (302) to disable the audio delivery capabilities (214) of the content delivery device (204) can be carried out by the summarization module (206) actively listening to commands received by the content delivery device (204), by the summarization module (206) polling the content delivery device (204) to identify the sound settings of the content delivery device (204), and so on.

In the example method of FIG. 3, detecting (208) that the audio delivery capabilities (214) of the content delivery device (204) have been disabled can alternatively include determining (306) that audio delivery components of the content delivery device (204) are malfunctioning. In the example method of FIG. 3, determining (306) that audio delivery components of the content delivery device (204) are malfunctioning may be carried out, for example, by inspecting error messages generated by the content delivery device (204), by running a health check on the audio delivery components of the content delivery device (204), and so on. Consider an example in which the content delivery device (204) is embodied as a laptop computer of desktop computer. In such an example, audio delivery components of the content delivery device (204) may be malfunctioning, for example, when the sound card of the content delivery device (204) is not operating because a driver for the sound card is corrupted.

In the example method of FIG. 3, detecting (208) that the audio delivery capabilities (214) of the content delivery device (204) have been disabled can alternatively include determining (308) that a content signal received by the content delivery device (204) does not include an audio signal that can be rendered by the content delivery device (204). Consider an example in which the content signal received by the content delivery device (204) is a digital television signal that is received by a television. In such an example, the content signal received by the content delivery device (204) may not include an audio signal that can be rendered by the content delivery device (204), for example, if the digital television signal does not include an audio signal because of inclement weather, because the content provider (200) is experiencing technical difficulties, and so on.

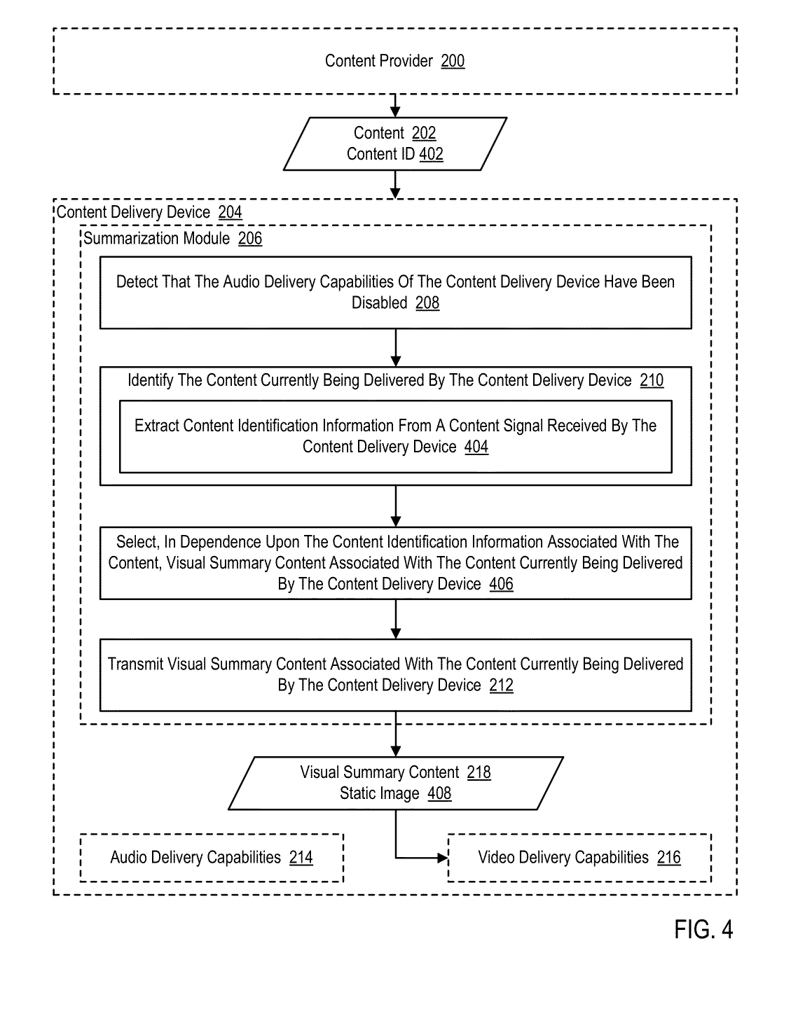

For further explanation, FIG. 4 sets forth a flow chart illustrating an example method for delivering content (202) via a content delivery device (204) that includes audio delivery capabilities (214) and video delivery capabilities (216) according to embodiments of the present invention. The example method of FIG. 4 is similar to the example method of FIG. 2, as it also includes detecting (208) that the audio delivery capabilities (214) of the content delivery device (204) have been disabled, identifying (210) the content (202) currently being delivered by the content delivery device (204), and transmitting (212) visual summary content (218) associated with the content (202) currently being delivered by the content delivery device (204).

The example method of FIG. 4 also includes selecting (406), in dependence upon an identification of the content (202) currently being delivered by the content delivery device (204), visual summary content (218) associated with the content currently being delivered by the content delivery device (204). In the example method of FIG. 4, an identification of the content (202) currently being delivered by the content delivery device (204) may be determined, for example, by extracting such information from a signal that includes the content (202). Selecting (406), in dependence upon an identification of the content (202) currently being delivered by the content delivery device (204), visual summary content (218) associated with the content currently being delivered by the content delivery device (204) may therefore be carried out, for example, by searching a table or other data repository that includes associations between various content IDs and static images.

In the example method of FIG. 4, identifying (210) the content (202) currently being delivered by the content delivery device (204) can include extracting (404) content identification information (402) from a content (202) signal received by the content delivery device (204). In the example method of FIG. 4, a content (202) signal received by the content delivery device (204) may include, embedded within the signal, information describing the content (202). Such information can include a name of the content (202), a brief description of the content (202), content identification information (402), and other information about the content (202). In such a way, the content delivery device (204) can extract (404) content identification information (402) from the content (202) signal that is received by the content delivery device (204).

In the example method of FIG. 4, the visual summary content (218) associated with the content (202) currently being delivered by the content delivery device (204) can include a static image (408) selected in dependence upon content identification (402) information associated with the content (202) currently being delivered by the content delivery device (204). The summarization module (206) of FIG. 4 may maintain a table or other data structure that associates content identification (402) information with a static image (408), such that a static image (408) for the content (202) currently being delivered by the content delivery device (204) can be selected by performing a table lookup using content identification (402) information to identify a static image (408) that is related to the content (202) currently being delivered by the content delivery device (204).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of delivering content via a content delivery device that includes audio delivery capabilities and video delivery capabilities, the method comprising:
detecting, by a summarization module, that the audio delivery capabilities of the content delivery device have been disabled;
identifying, by the summarization module, the content currently being delivered by the content delivery device; and
displaying, by the summarization module, visual summary content associated with the content currently being delivered by the content delivery device.

2. The method of claim 1 wherein detecting that the audio delivery capabilities of the content delivery device have been disabled further comprises receiving a user-initiated request to disable the audio delivery capabilities of the content delivery device.

3. The method of claim 1 wherein detecting that the audio delivery capabilities of the content delivery device have been disabled further comprises determining that audio delivery components of the content delivery device are malfunctioning.

4. The method of claim 1 further comprising selecting, in dependence upon an identification of the content currently being delivered by the content delivery device, visual summary content associated with the content currently being delivered by the content delivery device.

5. The method of claim 1 wherein identifying the content currently being delivered by the content delivery device includes extracting content identification information from a content signal received by the content delivery device.

6. The method of claim 1 wherein visual summary content associated with the content currently being delivered by the content delivery device includes a static image selected in dependence upon content identification information associated with the content currently being delivered by the content delivery device.

7. An apparatus for delivering content via a content delivery device that includes audio delivery capabilities and video delivery capabilities, the apparatus comprising a computer processor, a computer memory operatively coupled to the computer processor, the computer memory having disposed within it computer program instructions that, when executed by the computer processor, cause the apparatus to carry out the steps of:
detecting, by a summarization module, that the audio delivery capabilities of the content delivery device have been disabled;
identifying, by the summarization module, the content currently being delivered by the content delivery device; and
displaying, by the summarization module, visual summary content associated with the content currently being delivered by the content delivery device.

8. The apparatus of claim 7 wherein detecting that the audio delivery capabilities of the content delivery device have been disabled further comprises receiving a user-initiated request to disable the audio delivery capabilities of the content delivery device.

9. The apparatus of claim 7 wherein detecting that the audio delivery capabilities of the content delivery device have been disabled further comprises determining that audio delivery components of the content delivery device are malfunctioning.

10. The apparatus of claim 7 further comprising computer program instructions that, when executed by the computer processor, cause the apparatus to carry out the step of selecting, in dependence upon an identification of the content currently being delivered by the content delivery device, visual summary content associated with the content currently being delivered by the content delivery device.

11. The apparatus of claim 7 wherein identifying the content currently being delivered by the content delivery device includes extracting content identification information from a content signal received by the content delivery device.

12. The apparatus of claim 7 wherein visual summary content associated with the content currently being delivered by the content delivery device includes a static image selected in dependence upon content identification information associated with the content currently being delivered by the content delivery device.

13. A computer program product for delivering content via a content delivery device that includes audio delivery capabilities and video delivery capabilities, the computer program product disposed upon a computer readable medium, the computer program product comprising computer program instructions that, when executed, cause a computer to carry out the steps of:
detecting, by a summarization module, that the audio delivery capabilities of the content delivery device have been disabled;
identifying, by the summarization module, the content currently being delivered by the content delivery device; and
displaying, by the summarization module, visual summary content associated with the content currently being delivered by the content delivery device.

14. The computer program product of claim 13 wherein detecting that the audio delivery capabilities of the content delivery device have been disabled further comprises receiving a user-initiated request to disable the audio delivery capabilities of the content delivery device.

15. The computer program product of claim 13 wherein detecting that the audio delivery capabilities of the content delivery device have been disabled further comprises determining that audio delivery components of the content delivery device are malfunctioning.

16. The computer program product of claim 13 further comprising computer program product comprising computer program instructions that, when executed, cause the computer to carry out the step of selecting, in dependence upon an identification of the content currently being delivered by the content delivery device, visual summary content associated with the content currently being delivered by the content delivery device.

17. The computer program product of claim 13 wherein identifying the content currently being delivered by the content delivery device includes extracting content identification information from a content signal received by the content delivery device.

18. The computer program product of claim 13 wherein visual summary content associated with the content currently being delivered by the content delivery device includes a static image selected in dependence upon content identification information associated with the content currently being delivered by the content delivery device.

19. The computer program product of claim 13 wherein the computer readable medium comprises a computer readable signal medium.

20. The computer program product of claim 13 wherein the computer readable medium comprises a computer readable storage medium.
